(19) United States
(12) Patent Application Publication
(10) Pub. No.: US 2026/0319713 A1
(43) Pub. Date: Oct. 15, 2026

(54) STORAGE CONTROLLER WITH OUT-OF-BAND REMOTE MANAGEMENT FUNCTIONALITY

(71) Applicant: Microchip Technology Incorporated, Chandler, AZ (US)

(72) Inventors: Hariprasad Ramanujam, Bangalore (IN); Iyyappan R, Bangalore (IN)

(73) Assignee: Microchip Technology Incorporated, Chandler, AZ (US)

(21) Appl. No.: 19/244,060

(22) Filed: Jun. 20, 2025

(30) Foreign Application Priority Data
Apr. 11, 2025 (IN) 202511035530

(51) Int. Cl. G06F 3/06

(52) U.S. Cl. CPC G06F 3/0689; G06F 3/0604; G06F 3/0659; G06F 3/067

(57) ABSTRACT

Storage controllers with remote management functionality, and devices and systems incorporating the same, are disclosed herein. In one example, a storage controller card includes a storage controller and a remote management controller. The storage controller manages access to a plurality of storage devices, and the remote management controller manages access to the storage controller over a network and independently of a host processor.

### CROSS-REFERENCE TO RELATED APPLICATIONS

This patent application claims the benefit of the filing date of India Provisional Patent Application No. 202511035530, filed Apr. 11, 2025, and entitled “STORAGE CONTROLLER WITH OUT-OF-BAND REMOTE MANAGEMENT FUNCTIONALITY,” the contents of which are hereby expressly incorporated by reference.

### TECHNICAL FIELD

The present disclosure relates generally to storage controllers, and more particularly, to storage controllers with out-of-band remote management functionality.

### BACKGROUND

Storage controllers, such as redundant array of independent disks (RAID) controllers, rely on a host system for performing remote management and recovery operations. As a result, if the host system becomes unresponsive or the storage controller enters a lockup state, administrators face significant challenges in monitoring, managing, and even assessing the status of the storage controller. This makes it difficult to diagnose and resolve issues without physical access to the host system or storage controller, which leads to higher system downtime and administrative overhead.

### SUMMARY OF THE INVENTION

This disclosure presents examples of storage controller cards with onboard remote management functionality to enable a storage controller to be remotely managed independent of a host processor, along with devices and systems incorporating the same, and methods of using the same.

In one example, a storage controller card includes a storage controller and a remote management controller. The storage controller manages access to a plurality of storage devices, and the remote management controller manages access to the storage controller over a network and independently of a host processor.

In another example, a system includes a host processor and a storage controller card. The storage controller card includes a host input/output (I/O) interface to communicate with the host processor, a storage controller to manage access to a plurality of storage drives, and a remote management controller to manage access to the storage controller over a network.

In another example, a method performed by a remote management controller on a storage controller card includes: receiving, over a network from a client device, a management command associated with a storage controller on the storage controller card; executing the management command; and sending, over the network to the client device, a response to the management command.

### BRIEF DESCRIPTION OF THE DRAWINGS

FIG. 1 illustrates a storage controller card with an onboard remote management controller.

FIG. 2 illustrates a redundant array of independent disks (RAID) controller card with an onboard baseboard management controller.

FIG. 3 illustrates a block diagram of firmware for a remote management controller.

FIG. 4 illustrates a server with a storage controller card having an onboard remote management controller.

FIG. 5 illustrates a system for remotely managing a storage controller.

FIG. 6 illustrates a flowchart for a method of remotely managing a storage controller.

### DETAILED DESCRIPTION

A storage controller is used to manage the communication between a host system (e.g., a processor or server) and one or more storage devices, such as hard disk drives (HDDs), solid state drives (SSDs), tape drives, and other forms of non-volatile memory. In some cases, storage controllers are implemented in hardware as dedicated cards or embedded chips in system boards, and they often provide advanced functionality such as data redundancy, caching, and efficient input/output (I/O). As an example, a redundant array of independent disks (RAID) controller is a type of storage controller that manages multiple physical storage devices and presents them to a host system as one or more logical storage units for purposes of data redundancy, performance, or some combination of data redundancy and performance.

Storage controllers, such as RAID controllers, suffer from various limitations in remote management and recovery scenarios. A significant drawback is their reliance on the host system—such as an operating system or pre-boot environment on a host processor—to perform management operations (e.g., controller monitoring, configuration, command execution, debugging, and recovery). In particular, if the host system becomes unresponsive, administrators face significant challenges in monitoring, managing, or even assessing the status of the storage controller.

Moreover, current storage controllers lack support for remote debugging and recovery in the event of a controller lockup. In particular, when a storage controller enters a lockup state, administrators are often unable to retrieve diagnostic information, assess controller status, or initiate recovery procedures remotely. This makes it difficult to diagnose issues or restore functionality without physical access to the storage controller or host system.

As a result, these limitations hinder troubleshooting and failure recovery for storage controllers, and often involve physical in-person intervention to resolve issues, which ultimately increases system downtime and administrative overhead.

Accordingly, this disclosure presents examples of storage controllers with out-of-band remote management functionality. For example, a storage controller card may include an onboard remote management controller to enable out-of-band remote management without depending on a host system or processor. In some examples, the storage controller card may be a RAID controller card with a RAID controller and an onboard baseboard management controller (BMC) for out-of-band remote management of the RAID controller. In this manner, the disclosed examples enable more robust remote management, monitoring, and recovery of storage controllers, particularly in scenarios where the host system is inaccessible or the controller is in an unresponsive state.

In some examples, the onboard remote management controller may enhance the storage controller with remote management capabilities and other functionality, including, without limitation:
i. remotely accessing the storage controller via the management controller network port (e.g., using standardized protocols such as HTTPS and Redfish) without relying on the operating system or pre-boot environment of the host system;
ii. remotely monitoring and managing the storage controller (e.g., monitoring the controller status, events, alerts, health, temperature sensor, or power consumption, configuring the storage controller, executing commands on the storage controller);
iii. remotely accessing the serial console (e.g., command line interface) of the storage controller;
iv. remotely debugging the storage controller (e.g., remote access to a test interface such as the Joint Test Action Group (JTAG) test access port (TAP), booting passive firmware during controller lockup scenarios, generating debug logs);
v. remotely updating firmware of the storage controller, the remote management controller, or any other components on the storage controller card;
vi. sharing storage remotely (e.g., using storage area networking (SAN) protocols such as iSCSI); and
vii. simplifying the management tools for the storage controller (e.g., reducing the number of management tools by eliminating the management tools used in pre-boot or operating system environments).

The described examples may provide various advantages, including support for remote out-of-band management and monitoring of storage controllers, which may improve the robustness of storage controllers, reduce system downtime and administrative overhead due to failures, and provide more effective utilization of storage controller hardware.

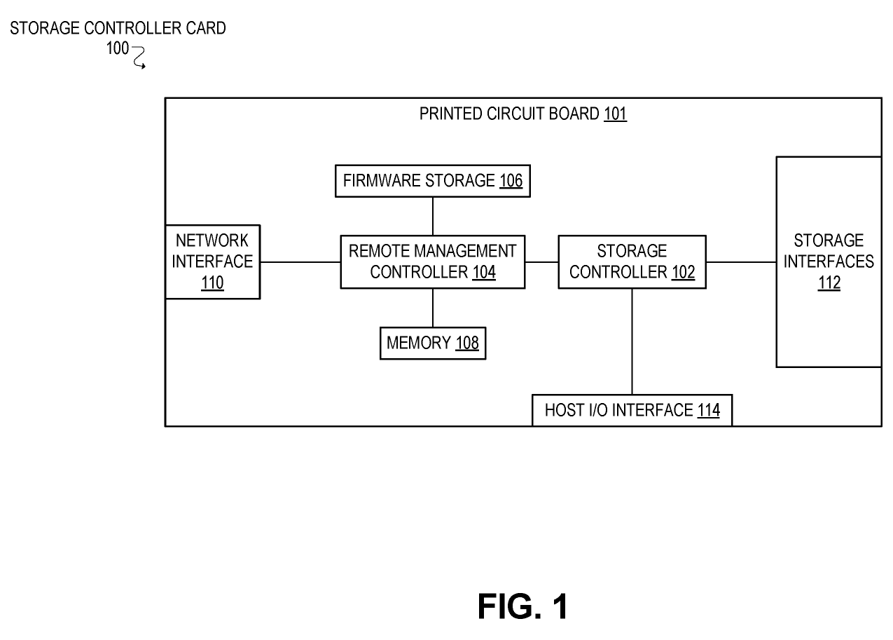

FIG. 1 illustrates an example of a storage controller card 100 with an onboard remote management controller (RMC) 104. In particular, the onboard RMC 104—along with the associated firmware storage 106, memory 108, and network interface 110—enable remote out-of-band management of a storage controller 102 on the storage controller card 100.

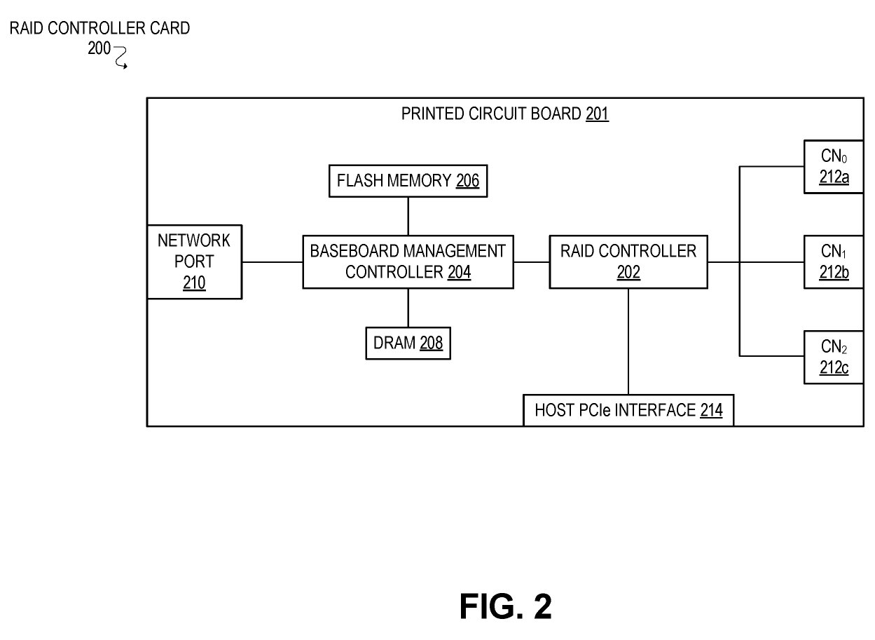

In the illustrated example, the storage controller 102 is used to manage one or more storage devices (not shown), which can be connected to the storage controller card 100 via the storage interfaces 112. In particular, the storage controller 102 may manage how data is stored on and retrieved from the storage devices, process read and write commands from a host system, perform error detection and correction, and perform failure recovery (e.g., when an individual sector on a storage drive, or an entire storage drive, suffers a failure), among other tasks. In some examples, the storage controller 102 may include RAID functionality (e.g., striping, mirroring, parity calculations, failure recovery) to manage the storage drives as a RAID array (e.g., similar to RAID controller 202 of FIG. 2).

Moreover, the onboard RMC 104 is a controller that provides out-of-band remote management functionality for the storage controller card 100 without depending on a host system. In particular, the RMC 104 can be used to monitor, manage, and control the storage controller card 100 remotely, independently of the host system’s processor (e.g., central processing unit (CPU)), firmware (e.g., Basic Input/Output System (BIOS), Unified Extensible Firmware Interface (UEFI)), and operating system. In this manner, the RMC 104 enables the storage controller card 100 to be managed remotely even when the host system or the storage controller 102 is powered off or otherwise unresponsive.

In particular, the RMC 104 has its own network interface 110 on the storage controller card 100 (e.g., to communicate remotely over a network with connected devices), which may be separate from the primary network interface on the host system. In this manner, the RMC 104 can communicate with a user (e.g., system administrator) over a network independently from the host system, thus enabling the user to remotely monitor, manage, and control components on the storage controller card 100 (e.g., storage controller 102) using the Internet Protocol (IP) address assigned to the network interface 110.

For example, the user may issue commands (e.g., using a client device) to the RMC 104 over the network to perform remote management operations with respect to components on the storage controller card 100. Moreover, the RMC 104 may receive the commands over the network (e.g., via the network interface 110), execute the commands, and then send a response back to the user’s client device over the network (e.g., via the network interface 110).

In some examples, the RMC 104 may communicate with the user using standard protocols or application programming interfaces (APIs) (e.g., representational state transfer (REST) APIs using hypertext transfer protocol secure (HTTPS)), such as Redfish or Intelligent Platform Management Interface (IPMI), or other vendor-specific APIs.

Moreover, in some examples, the storage controller 102 may also use the network interface 110 to share connected storage devices over a network (e.g., using storage area networking (SAN) protocols such as Internet Small Computer System Interface (iSCSI)), thus enabling other network devices to utilize the available storage on the storage devices.

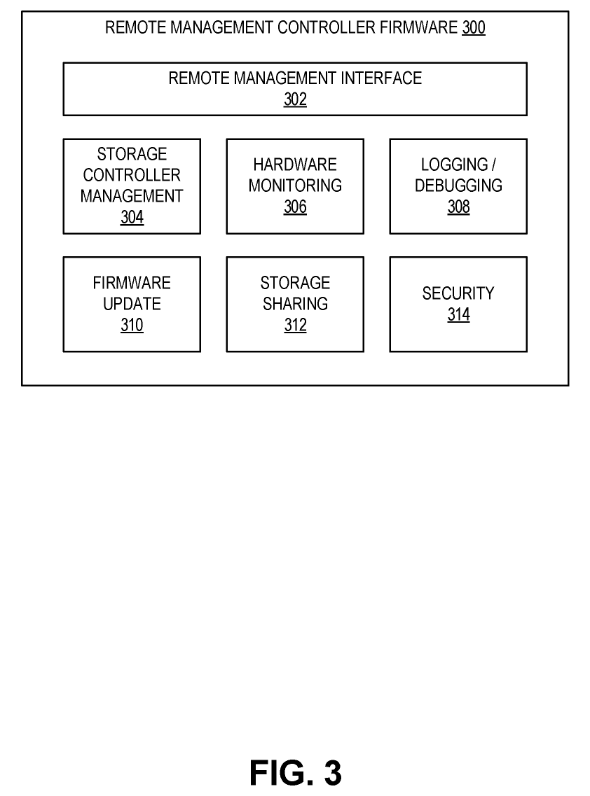

The RMC 104 also has its own firmware storage 106 and memory 108 on the storage controller card 100. The firmware storage 106 may be used to persistently store firmware (e.g., firmware 300 of FIG. 3) associated with the RMC 104, while the memory 108 may be used to store data associated with the RMC 104 during operation (e.g., firmware instructions executed by the RMC 104, data associated with operations performed by the firmware).

In this manner, a user may remotely issue a wide variety of commands to the RMC 104 to remotely monitor, manage, and control the storage controller card 100 (e.g., without relying on the operating system or pre-boot environment of the host system or processor).

For example, the user may remotely monitor the storage controller card 100 and its associated components, such as the storage controller 102 and any storage devices connected to the storage controller card 100 via the storage interfaces 112. In some examples, the user may remotely monitor or view the current status, health, events, alerts, configuration, logs, sensor data (e.g., temperature measured by a temperature sensor), or power usage/consumption of the storage controller 102 or the connected storage devices.

The user may remotely access a command line interface of the storage controller 102, such as the serial console of the storage controller 102. The user may execute commands on the storage controller 102 (e.g., to perform management operations or other administrative tasks, including RAID operations). The user may modify the configuration of the storage controller 102 (e.g., reconfigure the storage controller 102, update or modify certain configuration settings or properties).

In some examples, the user may configure the storage controller 102 to share the connected storage devices remotely over a network via the onboard network interface 110 (e.g., using storage area networking (SAN) protocols such as iSCSI). For example, storage volumes may be exposed using iSCSI to remotely share surplus storage on the array of storage devices with other network-connected devices.

The user may remotely update (or downgrade) the firmware of components on the storage controller card 100, such as the storage controller 102 or the RMC 104.

The user may remotely debug certain components on the storage controller card 100, such as the storage controller 102 or the RMC 104. For example, the user may remotely check the status of the storage controller 102 when the host system is unresponsive. The user may remotely access a test interface on the storage controller card 100, such as a JTAG test access port (TAP), to remotely test or debug the storage controller 102 or other components on the storage controller card 100. The user may access or generate debug logs associated with the storage controller 102. When the storage controller 102 is in an unresponsive state (e.g., controller lockup scenarios), the user may boot passive firmware on the storage controller 102 for debugging purposes.

The user may remotely power on, power off, or reboot the storage controller card 100, or certain components on the storage controller card 100 (e.g., storage controller 102, RMC 104).

In the illustrated example, the storage controller card 100 includes a printed circuit board (PCB) 101, a storage controller 102, a remote management controller (RMC) 104, firmware storage 106, memory 108, a network interface 110, storage interfaces 112, and a host input/output (I/O) interface 114.

The printed circuit board (PCB) 101 may be a physical board on which the various components of the storage controller card 100 are attached and electrically coupled (e.g., through conductive traces and vias in the board), thus enabling electrical communication among those components.

The storage controller 102 may include any suitable processing circuitry for implementing the functionality of a storage controller (e.g., managing access to one or more storage devices), including, without limitation, a microprocessor, a microcontroller, an application-specific integrated circuit (ASIC), or a field-programmable gate array (FPGA).

The RMC 104 may include any suitable processing circuitry for implementing remote management functionality associated with the storage controller card 100 and its underlying components (e.g., storage controller 102), including, without limitation, a microprocessor, a microcontroller, an ASIC, or an FPGA.

The firmware storage 106 may include any type of non-volatile memory (NVM), including, without limitation, flash memory such as Serial Peripheral Interface (SPI) flash memory (SPI flash), or forms of read-only memory (ROM).

The memory 108 may include any suitable type of volatile or non-volatile memory, such as random access memory (RAM), dynamic RAM (DRAM), synchronous DRAM (SDRAM), double data rate (DDR) SDRAM, or high bandwidth memory (HBM).

In some examples, the storage controller 102 may have its own firmware storage or memory (not shown) on the storage controller card 100 (e.g., separate from the firmware storage 106 and memory 108 of the RMC 104, but used for similar purposes by the storage controller 102), or the RMC 104 and the storage controller 102 may share firmware storage 106 or memory 108. Moreover, in some examples, the firmware storage 106 and memory 108 may be implemented by a single memory component (e.g., which serves the purpose of both firmware storage 106 and memory 108 using any type or combination of non-volatile or volatile memory).

The network interface 110 may include any suitable type of wired or wireless network interface and associated circuitry, including, without limitation, a physical network port or connector for a wired interface, such as a Registered Jack 45 (RJ-45) port (e.g., for Ethernet-based networking), or a wireless interface such as a Wi-Fi antenna, along with corresponding network interface controller (NIC) circuitry.

The storage interfaces 112 may include any suitable type of physical interfaces, connectors, or ports to interface with one or more storage drives (e.g., to connect the storage drives to the storage controller card 100 or otherwise communicate with them). In some examples, the storage interfaces 112 may include one or more serial attached small computer system interface (SAS) interfaces, serial advanced technology attachment (SATA) interfaces, or non-volatile memory express (NVMe) interfaces. Moreover, in some examples, the storage interfaces 112 may also include corresponding storage connectors (CN) or ports, which are physical ports used to interface with storage devices and connect them to the storage controller card 100 (e.g., using pluggable cables).

The host I/O interface 114 may include any suitable type of I/O interface for communicating with a host system or processor. In some examples, the host I/O interface 114 may include a Peripheral Component Interconnect Express (PCIe) connector (e.g., to interface with a corresponding PCIe slot on the host system).

In some examples, storage controller card 100 may be a RAID controller card with an onboard baseboard management controller (BMC) (e.g., similar to RAID controller card 200 of FIG. 2). For example, the storage controller 102 may include a RAID controller, and the RMC 104 may include a BMC.

FIG. 2 illustrates an example of a redundant array of independent disks (RAID) controller card 200 with an onboard baseboard management controller (BMC) 204. In particular, the onboard BMC 204—along with the associated flash memory 206, DRAM 208, and network port 210—enable remote out-of-band management of a RAID controller 202 on the RAID controller card 200.

In the illustrated example, RAID controller card 200 is similar to storage controller card 100 (e.g., with similar out-of-band remote management functionality). However, RAID controller card 200 includes a RAID controller 202, which is a type of storage controller that can manage multiple storage devices as a RAID array. For example, the RAID controller 202 can manage multiple physical storage devices and present them to a host system as one or more logical storage units for purposes of data redundancy, performance, or some combination of data redundancy and performance. In particular, the RAID controller 202 may support multiple schemes for distributing data across storage drives, referred to as RAID levels, each of which provides a different balance of data redundancy and performance. The RAID levels are typically numbered consecutively starting with 0, such as RAID 0, RAID 1, and so forth. For example, RAID 0 stripes (e.g., distributes) data across storage drives with no data redundancy, which increases performance but provides no fault tolerance, while higher RAID levels (e.g., RAID 1, RAID 5, RAID 10) provide some level of fault tolerance. The RAID controller 202 may handle tasks such as data striping, mirroring, parity calculations, and failure recovery (e.g., when an individual sector on a storage drive, or an entire storage drive, suffers a failure).

Moreover, RAID controller card 200 also includes an onboard baseboard management controller (BMC) 204, which is a particular type of remote management controller (e.g., similar to RMC 104) that provides out-of-band remote management functionality without depending on a host system. In particular, the BMC 204 can be used to monitor, manage, and control the RAID controller card 200 remotely, independently of the host system’s processor (e.g., CPU), firmware (e.g., BIOS, UEFI), and operating system. In this manner, the BMC 204 enables the RAID controller card 200 to be managed remotely even when the host system or the RAID controller 202 is powered off or otherwise unresponsive.

In particular, the BMC 204 has its own network port 210 on the RAID controller card 200 (e.g., to communicate remotely over a network with connected devices), which may be separate from the primary network port on the host system. In this manner, the BMC 204 can communicate with a user (e.g., system administrator) over a network independently from the host system, thus enabling the user to remotely monitor, manage, and control components on the RAID controller card 200 (e.g., RAID controller 202) using the IP address assigned to the network port 210.

For example, the user may issue commands (e.g., using a client device) to the BMC 204 over the network to perform any of the remote operations described throughout this disclosure (e.g., including any of the remote management operations described with respect to RMC 104 of storage controller card 100 or method 600). Moreover, the BMC 204 may receive the commands over the network (e.g., via the network port 210), execute the commands, and then send a response back to the user’s client device over the network (e.g., via the network port 210).

In some examples, the BMC 204 may communicate with the user using standard protocols or APIs, such as Redfish or IPMI, or other vendor-specific APIs.

Moreover, in some examples, the RAID controller 202 may also use the network port 210 to share connected storage devices over a network (e.g., using SAN protocols such as iSCSI).

The BMC 204 also has its own flash memory 206 and DRAM 208 on the RAID controller card 200. The flash memory 206 may be used to persistently store firmware (e.g., firmware 300 of FIG. 3) associated with the BMC 204, while the DRAM 208 may be used to store data associated with the BMC 204 during operation (e.g., firmware instructions executed by the BMC 204, data associated with operations performed by the firmware).

In the illustrated example, the RAID controller card 200 includes a printed circuit board (PCB) 201, a RAID controller 202, a baseboard management controller (BMC) 204, flash memory 206, dynamic random access memory (DRAM) 208, a network port 210, storage drive connectors (CN₀₋₂) 212a-c, and a host PCIe interface 214.

The printed circuit board (PCB) 201 may be a physical board on which the various components of the RAID controller card 200 are attached and electrically coupled (e.g., through conductive traces and vias in the board), thus enabling electrical communication among those components.

The RAID controller 202 may include any suitable processing circuitry for implementing the functionality of a RAID-based storage controller, including, without limitation, a microprocessor, a microcontroller, an ASIC, or an FPGA.

The BMC 204 may include any suitable processing circuitry for implementing baseboard management functionality for remote management of the RAID controller card 200 and its underlying components (e.g., RAID controller 202), including, without limitation, a microprocessor, a microcontroller, an ASIC, or an FPGA.

The flash memory 206 may include any type of non-volatile flash memory, including, without limitation, SPI flash memory (also referred to as SPI flash). In other examples, any other suitable type of non-volatile or volatile memory may be used instead of flash memory 206.

The DRAM 208 may include any type of DRAM, including, without limitation, SDRAM, DDR SDRAM, or high bandwidth memory (HBM). In other examples, any other suitable type of RAM, or other volatile or non-volatile memory, may be used instead of DRAM 208.

In some examples, the RAID controller 202 may have its own flash memory or DRAM (not shown) on the RAID controller card 200 (e.g., separate from the flash memory 206 and DRAM 208 of the BMC 204, but used for similar purposes by the RAID controller 202), or the BMC 204 and the RAID controller 202 may share flash memory 206 or DRAM 208. Moreover, in some examples, the flash memory 206 and DRAM 208 may be implemented by a single memory component (e.g., which serves the purpose of both flash memory 206 and DRAM 208 using any type or combination of non-volatile or volatile memory).

The network port 210 may include any suitable type of network port or connector, such as a Registered Jack 45 (RJ-45) port (e.g., for Ethernet-based networking).

The storage drive connectors (CN₀₋₂) 212a-c may include any suitable type of physical ports to connect storage devices to the RAID controller card 200 (e.g., using pluggable cables).

The host PCIe interface 214 may include a PCIe connector to interface with a host system or processor (e.g., via a corresponding PCIe slot on the host system). In other examples, any other suitable type of host I/O interface may be used instead of a PCIe interface 214.

FIG. 3 illustrates a block diagram of example firmware 300 for a remote management controller (RMC). In some examples, firmware 300 may be used to implement functionality of RMC 104 of FIG. 1 or BMC 204 of FIG. 2. In particular, firmware 300 may include instructions that, when executed by processing circuitry of an RMC (e.g., RMC 104, BMC 204), implement the remote management functionality described throughout this disclosure (e.g., with respect to RMC 104, BMC 204).

In some examples, firmware 300 may be persistently stored in non-volatile memory (e.g., firmware storage 106, flash memory 206) on a storage controller card (e.g., storage controller card 100, RAID controller card 200). Moreover, when the storage controller card is powered on, firmware 300 may be loaded into volatile memory (e.g., memory 108, DRAM 208), and the instructions of firmware 300 in volatile memory may be executed by processing circuitry on the RMC (e.g., RMC 104, BMC 204).

In the illustrated example, the functionality implemented by firmware 300 is organized into various logical software modules. In particular, firmware 300 includes remote management interface module 302, storage controller management module 304, hardware monitoring module 306, logging/debugging module 308, firmware update module 310, storage sharing module 312, and security module 314.

The remote management interface module 302 may provide a software interface, or application programming interface (API), for accessing the remote management controller on a storage controller card, such as a Redfish API.

The storage controller management module 304 may implement functionality for managing a storage controller on the storage controller card.

The hardware monitoring module 306 may implement functionality for monitoring the hardware on a storage controller card (e.g., the storage controller or associated components).

The logging/debugging module 308 may implement functionality for logging and debugging on a storage controller card (e.g., logging events, alerts, and failures associated with the storage controller, debugging the failures).

The firmware update module 310 may implement functionality for updating (e.g., upgrading or downgrading) firmware of components on the storage controller card, such as the storage controller or the remote management controller.

The storage sharing module 312 may implement functionality for sharing storage on the managed storage devices over a network. For example, the storage sharing module 312 may implement a storage area networking (SAN) protocol, such as Internet Small Computer System Interface (iSCSI), to share storage over a network.

The security module 314 may implement security-related functionality, including, without limitation, managing the users that are authorized to perform management commands, authenticating the users, and authorizing the management commands issued by the users.

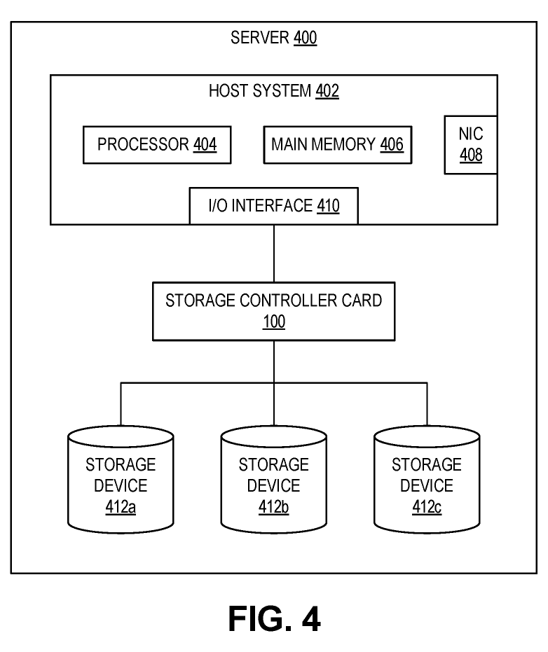

FIG. 4 illustrates an example of a server 400 with the storage controller card 100 of FIG. 1. For ease of illustration, the underlying components of storage controller card 100 are not shown in FIG. 4. As described above, however, storage controller card 100 includes a storage controller 102 and an onboard remote management controller (RMC) 104 (among other components). Moreover, while server 400 includes the storage controller card 100 of FIG. 1 in the illustrated example, server 400 may include any storage controller device with remote management functionality in other examples, including RAID controller card 200 of FIG. 2, among other examples.

In the illustrated example, server 400 includes a host system 402, storage controller card 100 (of FIG. 1), and storage devices 412a-c. The host system 402 and the storage controller card 100 are connected to each other via the I/O interface 410 on the host system 402 and the host I/O interface 114 on the storage controller card 100. The storage controller card 100 is connected to the storage devices 412a-c via the storage interfaces 112 (e.g., connectors/ports) on the storage controller card 100.

The host system 402 uses the storage controller 102 on the storage controller card 100 to manage access to the storage devices 412a-c. In some cases, a user (e.g., system administrator) may want to remotely manage the storage controller 102, such as when the host system 402 or the storage controller 102 becomes unresponsive, or when other administrative operations should be performed (e.g., updating firmware, reconfiguring storage controller settings, and so forth). In those cases, the user may perform remote management and recovery operations via the onboard RMC 104 on the storage controller card 100. For example, the user may utilize a client device (e.g., client device 504) to issue remote management commands for the storage controller 102 to the onboard RMC 104, which receives and process the commands to remotely manage the storage controller 102, as described throughout this disclosure.

In the illustrated example, the host system 402 includes a host processor 404, a main memory 406, a network interface controller (NIC) 408, and an I/O interface 410.

The host processor 404 may include any type of processing circuitry capable of implementing functionality of host system 402. In some examples, the host processor 404 may include, without limitation, a central processing unit (CPU), a graphics processing unit (GPU), a microprocessor, a microcontroller, a field-programmable gate array (FPGA), or an application-specific integrated circuit (ASIC).

The main memory 406 may include any type of volatile or non-volatile memory circuitry capable of storing data (e.g., data associated with applications or instructions executed by host processor 404). In some examples, the main memory 406 may include, without limitation, random access memory (RAM), such as dynamic RAM (DRAM) or static RAM (SRAM).

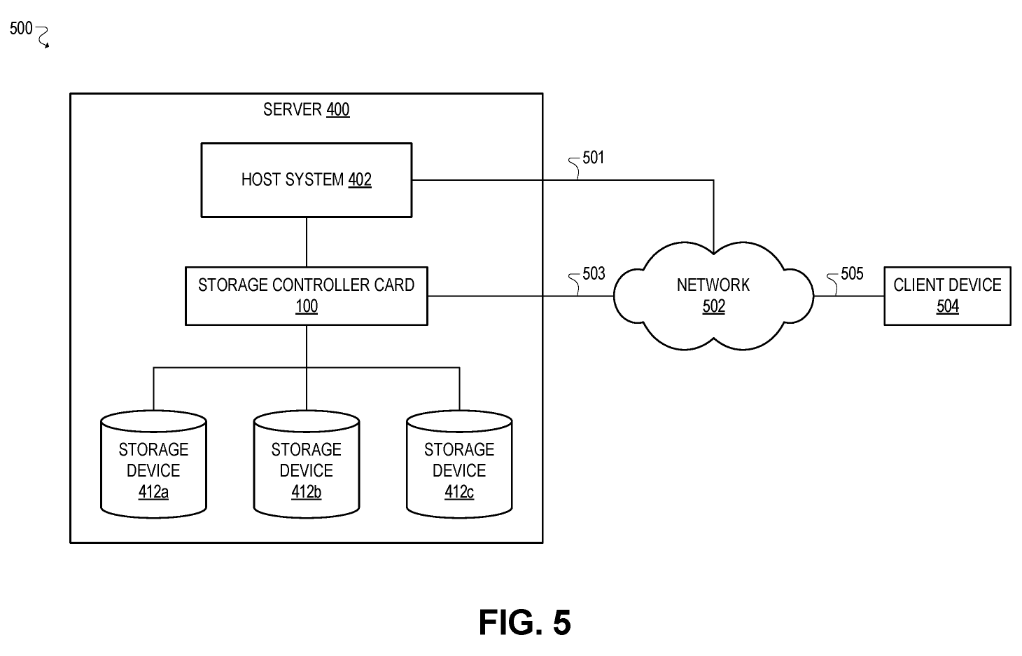

The NIC 408 may include any type of communication circuitry capable of enabling communication over a network between the host system 402 and another device. For example, in system 500 of FIG. 5, the NIC 408 may enable the host processor 404 of host system 402 to communicate with client device 504 over network 502.

In various examples, the NIC 408 may be configured to communicate using any suitable type or combination of wired or wireless communication technologies and associated protocols, including, without limitation, cellular technologies (e.g., 3rd Generation Partnership Project (3GPP) 4G or 5G cellular), wireless local area network (WLAN) technologies (e.g., Institute of Electrical and Electronics Engineers (IEEE) 802.11/Wi-Fi), wired or wireless wide area network (WAN) technologies (e.g., Internet, TCP/IP), Ethernet, Bluetooth, Bluetooth Low Energy, Internet-of-Things (IoT) communication technologies (e.g., IEEE 802.15.4 or ZigBee), or low-power wide area (LPWA) technologies (e.g., low-power wide area networks (LPWANs)).

The I/O interface 410 may include any suitable I/O interface for communicating with the storage controller card 100. In some examples, the I/O interface 410 may include a PCIe slot that interfaces with a PCIe connector on the storage controller card 100.

The storage devices 412a-c may include any type or combination of devices with non-volatile or volatile data storage capabilities, including, without limitation, hard disk drives (HDDs), solid state drives (SSDs), tape drives, or any forms of non-volatile or volatile memory.

FIG. 5 illustrates an example of a system 500 for remotely managing a storage controller 102. In the illustrated example, system 500 includes the server 400 of FIG. 4, a network 502, and a client device 504. As described above, the server 400 of FIG. 4 includes the storage controller card 100 of FIG. 1, which in turn includes a storage controller 102 and an onboard remote management controller (RMC) 104 (among other components). For ease of illustration, the underlying components of storage controller card 100 and host system 402 of server 400 are not shown in FIG. 5. Moreover, while system 500 includes the storage controller card 100 of FIG. 1 in the illustrated example, system 500 may include any storage controller device with remote management functionality in other examples, including RAID controller card 200 of FIG. 2, among other examples.

In the illustrated example, server 400 and client device 504 are both connected to network 502. However, client device 504 is connected to network 502 via a single connection 505, while server 400 is connected to network 502 via two separate connections 501, 503. In particular, the host system 402 of server 400 is connected to network 502 via connection 501 (e.g., via NIC 408 on the host system 402), and the storage controller card 100 of server 400 is connected to network 502 via connection 503 (e.g., via network interface 110 on storage controller card 100).

In this manner, a user (e.g., system administrator) can use client device 504 to send remote out-of-band management commands directly to the RMC 104 on the storage controller card 100 over network 502 (e.g., from client device 504 to network 502 via connection 505, and from network 502 to storage controller card 100 via connection 503), thus bypassing the host system 402 and enabling management of the storage controller 102 even when the host system 402 or the storage controller 102 is unresponsive.

Client device 504 may include any suitable electronic device for using, managing, or interacting with server 400 and its underlying components (e.g., storage controller card 100, host system 402) over network 502, including, without limitation, a personal computer (e.g., desktop or laptop computer), a tablet, a smartphone, a mobile device, an embedded system, or any other computing device.

Network 502 may include any type or combination of wired or wireless communication networks (e.g., using any of the communication technologies disclosed herein).

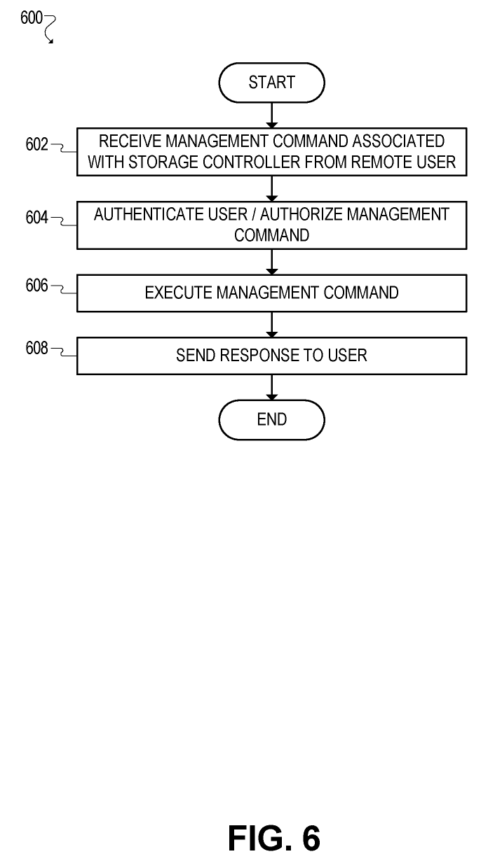

FIG. 6 illustrates a flowchart for a method 600 of remotely managing a storage controller. In some examples, the method 600 may be performed by a remote management controller (RMC) on a storage controller card (e.g., RMC 104 of storage controller card 100, BMC 204 of RAID controller card 200) to remotely manage a storage controller on the storage controller card. In particular, the remote management controller may perform the method 600 to receive and process remote management commands for the storage controller.

The flowchart begins at block 602 by receiving a management command from a client device of a remote user (e.g., over a network). The management command may be associated with managing a storage controller on the storage controller card.

For example, the management command may be a command to access a remote command line interface (e.g., remote serial console) of the storage controller, execute a command on the storage controller, update firmware of the storage controller, modify a configuration of the storage controller, view the configuration of the storage controller, view a current status of the storage controller, view a log associated with an operation of the storage controller, view sensor data associated with the storage controller, view power usage of the storage controller, configure the storage controller to share access to one or more storage drives over the network, or reboot the storage controller, among other examples.

The flowchart then proceeds to block 604 to authenticate the user and authorize the management command issued by the user.

In some examples, the user may be authenticated by verifying whether the user is authorized to manage the storage controller. For example, the user may be authenticated by verifying access credentials associated with the user, including, without limitation, username and password, an access key, a token, or any other suitable access credentials.

Moreover, the management command issued by the user may be authorized by verifying whether the user is authorized to issue the particular management command. In particular, in some examples, each user may be authorized to issue all, some, or none of the managements commands or other functionality for remotely managing the storage controller. In those examples, it may be determined whether the user’s access privileges or authorization level allows execution of the particular management command.

The flowchart then proceeds to block 606 to execute the management command. In particular, the management command may be executed to perform a corresponding operation, including, without limitation, any of the operations corresponding to the management commands referenced above at block 602.

The flowchart then proceeds to block 608 to send a response (e.g. over the network) to the client device of the user based on execution of the management command. The response sent to the user may vary depending on the particular management command issued by the user. For example, the response may include, without limitation, providing a command line interface, providing requested information (e.g., controller status, health, logs), or providing confirmation that a particular action was taken.

At this point, the flowchart may be complete. In some examples, however, the flowchart may restart or certain blocks may be repeated. For example, in some examples, the flowchart may restart at block 602 to continue receiving and processing remote management commands for the storage controller.

For ease of explanation, the concepts of this disclosure have been presented with reference to various illustrative examples, which have been described herein in detail and shown in the accompanying figures. However, the concepts of this disclosure are not limited to the particular examples disclosed, nor are the disclosed examples intended to be exhaustive. Rather, various modifications and alternative forms are also possible without departing from the spirit and scope of the concepts disclosed herein.

In the drawings, while some structural or method features may be shown in specific arrangements or orderings, such specific arrangements or orderings may be optional. In some examples, such features may be arranged in a different manner or order than shown in the drawings. Additionally, the inclusion of a structural or method feature in a particular drawing is not meant to imply that such feature is present in all examples and, in some examples, such feature may not be included or may be combined with other features. Further, the various examples shown in the drawings are illustrative representations and may not be drawn to scale. In some instances, the same or similar reference numerals may be used to designate the same or similar features in different drawings.

In the methods and process flows disclosed herein (e.g., method 600), additional operations may be performed beyond those that have been disclosed, certain operations may be omitted, or the order in which certain operations are performed may vary.

The disclosed examples may be implemented, in some cases, in hardware, firmware, software, or any combination thereof. The disclosed examples may also be implemented as instructions carried by or stored on one or more transitory or non-transitory machine-readable (e.g., computer-readable) storage media, which may be read and executed by processing circuitry (e.g., on one or more processors). A machine-readable storage medium may be embodied as any storage device, mechanism, or other physical structure for storing or transmitting information in a form readable by a machine, including volatile or non-volatile memory (e.g., random access memory (RAM), flash memory), hard drives (e.g., hard disk drive (HDD), solid state drive (SSD)), media discs, or combinations thereof.

### Examples

Examples of the technologies disclosed herein are provided below.

Example 1 includes a storage controller card, comprising: a storage controller to manage access to a plurality of storage devices; and a remote management controller to manage access to the storage controller over a network and independently of a host processor.

Example 2 includes the storage controller card of Example 1, wherein the remote management controller comprises a baseboard management controller.

Example 3 includes the storage controller card of any of Examples 1-2, wherein the storage controller comprises a redundant array of independent disks (RAID) controller.

Example 4 includes the storage controller card of any of Examples 1-3, wherein the storage controller card is a redundant array of independent disks (RAID) controller card.

Example 5 includes the storage controller card of any of Examples 1-4, further comprising: a plurality of storage ports to communicate with the plurality of storage devices; a network port to communicate over the network; and a host input/output (I/O) interface to communicate with the host processor.

Example 6 includes the storage controller card of Example 5, wherein the host I/O interface comprises a peripheral component interconnect express (PCIe) connector.

Example 7 includes the storage controller card of any of Examples 5-6, further comprising a printed circuit board (PCB), wherein the storage controller, the remote management controller, the storage ports, and the network port are coupled to the PCB.

Example 8 includes the storage controller card of any of Examples 1-7, further comprising: a non-volatile memory to store firmware associated with the remote management controller; and a random access memory to store data associated with the remote management controller.

Example 9 includes the storage controller card of Example 8, wherein: the non-volatile memory comprises flash memory; and the random access memory comprises dynamic random access memory (DRAM).

Example 10 includes the storage controller card of Example 9, wherein the flash memory comprises serial peripheral interface (SPI) flash memory.

Example 11 includes the storage controller card of any of Examples 1-10, wherein the remote management controller is further to: receive, over the network from a client device, a management command associated with the storage controller; execute the management command; and send, over the network to the client device, a response to the management command.

Example 12 includes the storage controller card of Example 11, wherein the management command is to: access a remote command line interface of the storage controller; execute a command on the storage controller; update firmware of the storage controller; modify a configuration of the storage controller; view the configuration of the storage controller; view a current status of the storage controller; view a log associated with an operation of the storage controller; view sensor data associated with the storage controller; view power usage of the storage controller; configure the storage controller to share access to one or more storage drives over the network; or reboot the storage controller.

Example 13 includes the storage controller card of any of Examples 1-12, wherein the host processor comprises a central processing unit (CPU).

Example 14 includes a storage controller card, comprising: a storage controller to manage access to a plurality of storage devices; a remote management controller to manage the storage controller remotely over a network; a plurality of storage interfaces to communicate with the plurality of storage devices; a network interface to communicate over the network; and a host input/output (I/O) interface to communicate with a host processor.

Example 15 includes the storage controller card of Example 14, wherein the remote management controller is further to manage the storage controller independently of the host processor.

Example 16 includes the storage controller card of any of Examples 14-15, wherein: the plurality of storage interfaces comprise a plurality of storage ports, wherein the plurality of storage ports are to interface with the plurality of storage devices; and the network interface comprises a network port.

Example 17 includes the storage controller card of any of Examples 14-16, wherein the plurality of storage interfaces include one or more of: a serial attached small computer system interface (SAS) interface; a serial advanced technology attachment (SATA) interface; or a non-volatile memory express (NVMe) interface.

Example 18 includes the storage controller card of any of Examples 14-17, wherein the host I/O interface comprises a peripheral component interconnect express (PCIe) connector.

Example 19 includes a redundant array of independent disks (RAID) controller card, comprising: a RAID controller to manage access to a plurality of storage drives; a baseboard management controller to manage access to the RAID controller over a network; a plurality of storage ports to communicate with the plurality of storage drives; a network port to communicate over the network; and a host input/output (I/O) interface to communicate with a host processor.

Example 20 includes the RAID controller card of Example 19, further comprising a printed circuit board (PCB), wherein the RAID controller, the baseboard management controller, the storage ports, the network port, and the host I/O interface are coupled to the PCB.

Example 21 includes the RAID controller card of any of Examples 19-20, further comprising: a flash memory to store firmware associated with the baseboard management controller; and a random access memory to store data associated with the baseboard management controller.

Example 22 includes the RAID controller card of Example 21, wherein: the flash memory comprises serial peripheral interface (SPI) flash memory; and the random access memory comprises dynamic random access memory (DRAM).

Example 23 includes the RAID controller card of any of Examples 19-22, wherein the host I/O interface comprises a peripheral component interconnect express (PCIe) connector.

Example 24 includes a system, comprising: a host processor; and a storage controller card, wherein the storage controller card comprises: a host input/output (I/O) interface to communicate with the host processor; a storage controller to manage access to a plurality of storage drives; and a remote management controller to manage access to the storage controller over a network.

Example 25 includes the system of Example 24, wherein the remote management controller is further to manage access to the storage controller independently of the host processor.

Example 26 includes the system of any of Examples 24-25, wherein: the storage controller comprises a redundant array of independent disks (RAID) controller; and the remote management controller comprises a baseboard management controller.

Example 27 includes the system of any of Examples 24-26, wherein the host processor comprises a central processing unit (CPU).

Example 28 includes the system of any of Examples 24-27, wherein the storage controller card further comprises: a plurality of storage ports to communicate with the plurality of storage drives; and a network port to communicate over the network.

Example 29 includes the system of any of Examples 24-28, wherein the storage controller card further comprises a plurality of storage interfaces to communicate with the plurality of storage drives, wherein the plurality of storage interfaces include one or more of: a serial attached small computer system interface (SAS) interface; a serial advanced technology attachment (SATA) interface; or a non-volatile memory express (NVMe) interface.

Example 30 includes the system of any of Examples 24-29, further comprising the plurality of storage drives.

Example 31 includes the system of any of Examples 24-30, wherein the plurality of storage drives include one or more of a hard disk drive, a solid state drive, or a tape drive.

Example 32 includes a method performed by a remote management controller on a storage controller card, comprising: receiving, over a network from a client device, a management command associated with a storage controller, wherein the storage controller is on the storage controller card; executing the management command; and sending, over the network to the client device, a response to the management command.

Example 33 includes the method of Example 32, further comprising: authenticating the client device; and authorizing the management command from the client device.

Example 34 includes the method of any of Examples 32-33, wherein: the storage controller comprises a redundant array of independent disks (RAID) controller; and the remote management controller comprises a baseboard management controller.

Example 35 includes the method of any of Examples 32-34, wherein the management command is received via a Redfish application programming interface.

Example 36 includes the method of any of Examples 32-35, wherein the management command is to: access a remote command line interface of the storage controller; execute a command on the storage controller; update firmware of the storage controller; modify a configuration of the storage controller; view the configuration of the storage controller; view a current status of the storage controller; view a log associated with an operation of the storage controller; view sensor data associated with the storage controller; view power usage of the storage controller; configure the storage controller to share access to one or more storage drives over the network; or reboot the storage controller.

Example 37 includes one or more non-transitory machine-readable storage media having instructions stored thereon, wherein the instructions, when executed by processing circuitry, cause the processing circuitry to perform the method of any of Examples 32-36.

1. A storage controller card, comprising:
a storage controller to manage access to a plurality of storage devices; and
a remote management controller to manage access to the storage controller over a network and independently of a host processor.

2. The storage controller card of claim 1, wherein the remote management controller comprises a baseboard management controller.

3. The storage controller card of claim 1, wherein the storage controller comprises a redundant array of independent disks (RAID) controller.

4. The storage controller card of claim 1, further comprising:
a plurality of storage ports to communicate with the plurality of storage devices;
a network port to communicate over the network; and
a host input/output (I/O) interface to communicate with the host processor.

5. The storage controller card of claim 4, wherein the host I/O interface comprises a peripheral component interconnect express (PCIe) connector.

6. The storage controller card of claim 4, further comprising a printed circuit board (PCB), wherein the storage controller, the remote management controller, the storage ports, and the network port are coupled to the PCB.

7. The storage controller card of claim 1, further comprising:
a non-volatile memory to store firmware associated with the remote management controller; and
a random access memory to store data associated with the remote management controller.

8. The storage controller card of claim 7, wherein:
the non-volatile memory comprises flash memory; and
the random access memory comprises dynamic random access memory (DRAM).

9. The storage controller card of claim 8, wherein the flash memory comprises serial peripheral interface (SPI) flash memory.

10. The storage controller card of claim 1, wherein the remote management controller is further to:
receive, over the network from a client device, a management command associated with the storage controller;
execute the management command; and
send, over the network to the client device, a response to the management command.

11. A system, comprising:
a host processor; and
a storage controller card, wherein the storage controller card comprises:
a host input/output (I/O) interface to communicate with the host processor;
a storage controller to manage access to a plurality of storage drives; and
a remote management controller to manage access to the storage controller over a network.

12. The system of claim 11, wherein the remote management controller is further to manage access to the storage controller independently of the host processor.

13. The system of claim 11, wherein:
the storage controller comprises a redundant array of independent disks (RAID) controller; and
the remote management controller comprises a baseboard management controller.

14. The system of claim 11, wherein the host processor comprises a central processing unit (CPU).

15. The system of claim 11, wherein the storage controller card further comprises:
a plurality of storage ports to communicate with the plurality of storage drives; and
a network port to communicate over the network.

16. The system of claim 11, wherein the storage controller card further comprises a plurality of storage interfaces to communicate with the plurality of storage drives, wherein the plurality of storage interfaces include one or more of:
a serial attached small computer system interface (SAS) interface;
a serial advanced technology attachment (SATA) interface; or
a non-volatile memory express (NVMe) interface.

17. The system of claim 11, wherein the plurality of storage drives include one or more of a hard disk drive, a solid state drive, or a tape drive.

18. A method performed by a remote management controller on a storage controller card, comprising:
receiving, over a network from a client device, a management command associated with a storage controller, wherein the storage controller is on the storage controller card;
executing the management command; and
sending, over the network to the client device, a response to the management command.

19. The method of claim 18, wherein the management command is received via a Redfish application programming interface.

20. The method of claim 18, wherein the management command is to:
access a remote command line interface of the storage controller;
execute a command on the storage controller;
update firmware of the storage controller;
modify a configuration of the storage controller;
view the configuration of the storage controller;
view a current status of the storage controller;
view a log associated with an operation of the storage controller;
view sensor data associated with the storage controller;
view power usage of the storage controller;
configure the storage controller to share access to one or more storage drives over the network; or
reboot the storage controller.
